(19) United States
(12) Patent Application Publication
(10) Pub. No.: US 2016/0214905 A1
(43) Pub. Date: Jul. 28, 2016

(54) REFRACTORY BRICKS AND METHODS OF MAKING THE SAME

(71) Applicant: RESCO PRODUCTS, INC., PITTSBURGH, PA (US)

(72) Inventor: CHRISTOPHER L. MACEY, OAKDALE, PA (US)

(21) Appl. No.: 15/003,846

(22) Filed: Jan. 22, 2016

Related U.S. Application Data
(60) Provisional application No. 62/107,142, filed on Jan. 23, 2015.

(51) Int. Cl. C04B 35/66; F27B 7/28; F27D 1/06; C04B 35/63; C04B 35/64

(52) U.S. Cl. CPC C04B 35/66; C04B 35/63; C04B 35/64; F27D 1/063; F27B 7/28

(57) ABSTRACT

A refractory brick including a refractory composition comprising, by weight based on total weight of the composition: 5% to 50% olivine; 3.5% to 35% magnesia-alumina spinel; optionally, 1% to 10% alumina; and the balance essentially magnesite and impurities. In certain non-limiting embodiments, the refractory brick can have a thermal conductivity of 2.6 W/(m·K) or less when tested at 1400° C., while maintaining a coefficient of thermal expansion of 12.6×10⁻⁶/° C. or less.

### REFERENCE TO PENDING PRIOR PATENT APPLICATION

This patent application claims the benefit of U.S. Provisional Patent Application No. 62/107,142, filed on Jan. 23, 2015, which is hereby incorporated herein by reference.

### BACKGROUND OF THE TECHNOLOGY

1. Field of Technology

The present disclosure relates to refractory bricks and methods of making refractory bricks. In particular, certain non-limiting aspects of the present disclosure relate to a refractory brick including certain materials and having advantageous thermal properties.

2. Description of the Background of the Technology

A rotary kiln is a furnace including a rotating hollow cylinder, which can be used to heat treat certain minerals such as, for example, limestone, portland cement clinker, and other minerals, by passing the materials through the interior of the cylinder. Typically, a rotary lime kiln has a shell diameter between 2.4 m and 5.2 m. The shell has a mild angle of slope from a kiln inlet end to a kiln discharge end, so that the rotating kiln can convey the feed mineral from the inlet end to the discharge end. The area of highest operating temperature within the rotary kiln is known as the “burning zone”. Rotary lime kilns typically operate within a maximum temperature range of 1093° C. to 1400° C. at the burning zone. The kiln shell is normally made from mild steel. Mild steel can have temperature limitations to maintain suitable strength and, therefore, the interior surface of a rotary lime kiln is lined with individual refractory elements, known in the industry as refractory “bricks,” to insulate the steel kiln shell from the high temperatures within the kiln's interior. For example, mild steel can lose strength if maintained at temperatures above 440° C. and, therefore, a lime kiln shell temperature is preferably kept below about 427° C. by the thermally insulating properties of the refractory brick lining. Particularly desirable kiln shell temperatures for a rotary lime kiln are in the range of 260° C. to 371° C. Generally, the lower the kiln shell temperature, the better for maintaining the strength properties of the steel kiln shell.

Shell temperatures for a rotary lime kiln can be a function of factors including the operating temperature of the burning zone, the insulating value (sometimes also referred to as “the K-factor”) of the refractory bricks lining the interior of the kiln, and the thickness of the refractory brick lining. In addition to protecting the kiln shell, the insulating value of the refractory bricks can significantly affect the efficiency of a rotary lime kiln, because a high kiln shell temperature can increase heat loss, thereby increasing fuel consumption and production cost to maintain the desired burning zone temperature. Therefore, in a rotary kiln shell it is important to provide refractory bricks having a relatively low thermal conductivity.

### SUMMARY

One non-limiting aspect of the present disclosure is directed to embodiments of a refractory composition, and to a refractory brick including the refractory composition. The refractory composition comprises, by weight based on total weight of the composition: 5% to 50% olivine; 3.5% to 35% magnesia-alumina spinel; optionally, 1% to 10% alumina; and the balance essentially magnesite and impurities.

A non-limiting aspect of the present disclosure is directed to embodiments of a method of forming a refractory brick. The method comprises: forming a mix comprising, by weight based on the total weight of the mix, 5% to 50% olivine, 3.5% to 35% magnesia-alumina spinel, optionally, 1% to 10% alumina, and the balance essentially magnesite and impurities; adding at least one temporary binder to the mix; and pressing at least a portion of the mix and the temporary binder into a refractory brick.

### BRIEF DESCRIPTION OF THE DRAWINGS

Features and advantages of the compositions, methods, and articles described herein may be better understood by reference to the accompanying drawings in which:

FIG. 1 is a graph plotting thermal conductivity as a function of temperature for certain non-limiting embodiments of a refractory composition according to the present disclosure (“Example 1,” “Example 2,” and “Example 5”) and for a conventional refractory composition (“Reference”);

FIG. 2 is a graph plotting linear thermal expansion as a function of temperature for certain non-limiting embodiments of a refractory composition according to the present disclosure (“Example 1,” “Example 2,” and “Example 4”) and for a conventional refractory composition (“Reference”); and

FIG. 3 is a flow chart of a non-limiting embodiment of a method of forming a refractory brick according to the present disclosure.

The reader will appreciate the foregoing details, as well as others, upon considering the following detailed description of certain non-limiting embodiments of compositions, methods, and articles according to the present disclosure. The reader also may comprehend certain of such additional details upon using the compositions, methods, and articles described herein.

### DETAILED DESCRIPTION OF CERTAIN NON-LIMITING EMBODIMENTS

In the present description of non-limiting embodiments and in the claims, other than in the operating examples or where otherwise indicated, all numbers expressing quantities or characteristics of ingredients and products, processing conditions, and the like are to be understood as being modified in all instances by the term “about.” Accordingly, unless indicated to the contrary, any numerical parameters set forth in the following description and the attached claims are approximations that may vary depending upon the desired properties one seeks to obtain in the compositions, methods, and articles according to the present disclosure. At the very least, and not as an attempt to limit the application of the doctrine of equivalents to the scope of the claims, each numerical parameter should at least be construed in light of the number of reported significant digits and by applying ordinary rounding techniques.

The present disclosure, in part, is directed to refractory bricks including refractory compositions having advantageous thermal properties. A refractory “brick” is a term of art and will be readily understood by those having ordinary skill in the production of refractory compositions. The specific shape of the refractory brick may vary depending upon the size and other design criteria of the particular kiln in which it is utilized. Typically, a refractory brick for use in a kiln is shaped for being assembled in stacked relationship around the kiln, and, therefore, may include slightly curved or tapered sides. It is to be understood, however, that the term “brick” as used herein is intended in a generic sense and is not limited to any specific configuration or shape so long as it can serve as component of an inner refractory lining of a kiln shell. Certain embodiments of refractory compositions according to the present disclosure comprise, by weight based on total weight of the composition, 5% to 50% olivine, 3.5% to 35% magnesia-alumina spinel, optionally, 1% to 10% alumina, and the balance essentially magnesite and impurities.

According to certain non-limiting embodiments, the olivine content of certain embodiments of refractory compositions according to the present disclosure is 20%, by weight. “Olivine” is a term of art and will be readily understood by those having ordinary skill in the production of refractory compositions and refractory bricks. Naturally occurring olivine refers to an inert, hydration free mineral produced from intrusive or effusive volcanic rocks and having a composition conforming to the orthosilicate formula 2RO—SiO₂, where RO can be MgO, FeO, MnO, or similar oxides. In certain non-limiting embodiments, olivine includes a solid solution of 90% by weight forsterite (2MgO—SiO₂) and 10% by weight fayalite (2FeO—SiO₂). Olivine can also contain 5% to 8% of other magnesia-silica minerals. In certain non-limiting embodiments, olivine can refer to a synthesized olivine. Synthesized olivine can be predominantly forsterite, e.g., synthesized olivine can include 50% or more forsterite. In certain non-limiting embodiments, synthesized olivine includes, by weight, 50-60% forsterite, 25-30% enstatite (MgSiO₃), 2-8% hematite (Fe₂O₃), and 8-10% magnesio-ferrite (MgFe₂O₄).

For rotary kilns, the thermal expansion of refractory bricks lining the interior surfaces can be an important consideration. The refractory bricks must remain intact and in place in the interior of the kiln and suitably insulate the kiln shell from the interior operating temperatures. Similar to other structural materials, refractory bricks expand when heated and contract when cooled. The coefficient of linear thermal expansion is a measure of how much a structure expands linearly when heated to a given temperature. If the linear thermal expansion of a kiln's refractory brick is excessive, expansion at operating temperatures can render the lining unstable. For example, when a refractory lining in a rotary kiln is heated, compressive stresses can result if the refractory lining is restrained from expanding. If the coefficient of linear thermal expansion is too high, excessive compressive stresses can develop within a refractory lining and cause cracks to form in the refractory brick, potentially damaging the refractory lining. Thus, it is important to limit the linear thermal expansion properties of refractory compositions used in refractory brick.

Olivine can exhibit linear thermal expansion properties comparable to dead-burned magnesite (magnesium oxide). Bricks consisting primarily of magnesite are known to be unsuitable as a lining in rotary lime and cement kilns due to high linear thermal expansion, which can cause the lining to fail during kiln operation. Therefore, the present inventor expected that the linear thermal expansion properties of olivine, which are known to be comparable to those of dead-burned magnesite, likewise render refractory brick consisting of olivine unsuitable as a lining material in dynamic, rotating kilns. The present inventor, however, unexpectedly discovered that a refractory composition including olivine and magnesia-alumina spinel exhibits reduced linear thermal expansion relative to olivine alone and is suitable for use in refractory bricks for lining rotary lime and cement kilns. Further, the present inventor unexpectedly observed that a novel refractory composition according to the present disclosure including olivine and magnesia-alumina spinel exhibits linear thermal expansion less than a conventional refractory composition, while also advantageously significantly reducing thermal conductivity, as further explained below.

According to certain non-limiting embodiments, the magnesite of the refractory composition of the present disclosure has an MgO content of 88% to 99% by weight. In certain non-limiting embodiments, an MgO content of 95% may be selected for the magnesite used in non-limiting embodiments of the refractory composition herein. Such an MgO content may be particularly suitable in refractory bricks used in rotary lime kilns, where maximum processing temperatures are lower than for Portland cement kilns, for which an MgO content of 97% may be more suitable. In further non-limiting embodiments, the magnesite of the refractory composition has a total lime (CaO) and silica (SiO₂) content of 0.7% to 10%, by weight.

According to certain non-limiting embodiments, the magnesite of the refractory composition according to the present disclosure comprises at least one material selected from dead-burned magnesite and fused magnesite. “Dead-burned magnesite” or “sintered magnesite” are terms of art and will be readily understood by those having ordinary skill in the production of refractory compositions and refractory bricks. A dead-burned or sintered magnesite can refer to a refractory raw material derived from either natural magnesite ores (MgCO₃) or a synthetic magnesium hydroxide (Mg(OH)₂) precipitated by chemical reactions with either sea water or brines, and thermally processed at very high temperatures, e.g., above 1700° C., to produce a refractory grain of high density and high purity. The resultant dead-burned magnesite includes periclase, which is the crystalline form of magnesium oxide (MgO). As known in the art, fused variants of the dead-burned magnesites can be obtained by heating calcined or dead-burned magnesia to a temperature at which the material melts (generally, above 2204° C.). Upon solidification, large crystallites are formed, which generally have a high grain density, low porosity, and reduced surface area for reaction. Therefore, fused magnesite can exhibit an increased resistance to corrosion by liquid and gaseous furnace charges.

The present inventor has observed that when magnesia-alumina spinel is added to a refractory composition including a magnesite having an MgO content of 88% to 99%, by weight, the thermal conductivity of the resulting composition can be reduced, the resistance to cracking and spalling due to thermal cycling can be increased, and the thermal expansion can be reduced. “Spinel” is a term of art and will be readily understood by those having ordinary skill in the production of refractory compositions and refractory bricks. A “spinel” refers to a group of minerals that crystallize in the cubic system and which have the formula RO—R′₂O₃, where R is either magnesium or iron, and where R′ is typically iron, aluminum, or chromium. A magnesia-alumina spinel is primarily composed of magnesia (MgO) and alumina (Al₂O₃). Magnesia-alumina spinel may be prepared by blending magnesia and an alumina source, e.g., bauxite or chemical grade alumina, densifying, and then sintering at very high temperatures similar to dead-burned magnesia, or melting the mixture in a manner similar to the preparation of fused magnesite. According to certain non-limiting embodiments, the magnesia-aluminum spinel content of the refractory composition is 10% by weight.

In certain non-limiting embodiments, the magnesia-alumina spinel in the refractory composition according to the present disclosure includes MgO and Al₂O₃ in a stoichiometric ratio of approximately 28.3% MgO and 71.7% Al₂O₃. In other non-limiting embodiments, the composition of the magnesia-alumina spinel is magnesia-rich by including a slight excess of magnesia. For example, the magnesia-alumina spinel can include, by weight, 29.6% MgO, 65.7% Al₂O₃, 1.2% SiO₂, 2.52% TiO₂, 0.54% Fe₂O₃, and 0.36% CaO. In other embodiments, the magnesia-alumina spinel can include, by weight, 27% to 31% MgO and 62% to 72.2% Al₂O₃. As discussed above, the present inventor has observed that the addition of magnesia-alumina spinel to a refractory composition including olivine can reduce the linear thermal expansion of the refractory composition to a range suitable for a refractory lining of a rotary kiln.

According to certain non-limiting embodiments, the refractory composition according to the present disclosure comprises, by weight, 1% to 10% alumina. According to further non-limiting embodiments, the alumina in the refractory composition can be sintered with the magnesite, thereby forming additional magnesia-alumina spinel in situ during heating or firing of the refractory brick. The so-formed additional in-situ magnesia-alumina spinel can further reduce thermal conductivity, increase strength, and improve resistance of the refractory composition to penetration and reaction. In certain other non-limiting embodiments, however, the refractory composition may not include alumina, and the magnesia-alumina spinel is predominantly pre-formed rather than formed in situ.

According to certain non-limiting embodiments, the alumina used to form in-situ magnesia-alumina spinel is of sufficiently fine sizing to react with fine magnesite in the mix. The alumina can be selected from the group of raw materials commonly used in refractory manufacture, including calcined alumina, tabular alumina, white fused alumina, brown fused alumina, reactive alumina, and hydrous alumina. According to certain non-limiting embodiments, at least one raw material selected from bauxite, mullite, and kyanite may be used as a source of the alumina.

According to certain non-limiting embodiments, the refractory composition has a thermal conductivity of 2.6 W/(m·K) or less at 1400° C. According to further non-limiting embodiments, the refractory composition has a thermal conductivity of approximately 2.5 W/(m·K) at 1093° C. Depending on the use requirements or preferences for the particular refractory composition, the thermal conductivity of the refractory composition may slightly exceed 2.6 W/(m·K) at 1400° C. and/or may slightly exceed 2.5 W/(m·K) at 1093° C. According to still further non-limiting embodiments, the refractory composition has a coefficient of thermal expansion of 12.6×10⁻⁶/° C. or less. Depending on the use requirements or preferences for the particular refractory composition, in certain embodiments the coefficient of thermal expansion of the refractory composition may slightly exceed 12.6×10⁻⁶/° C.

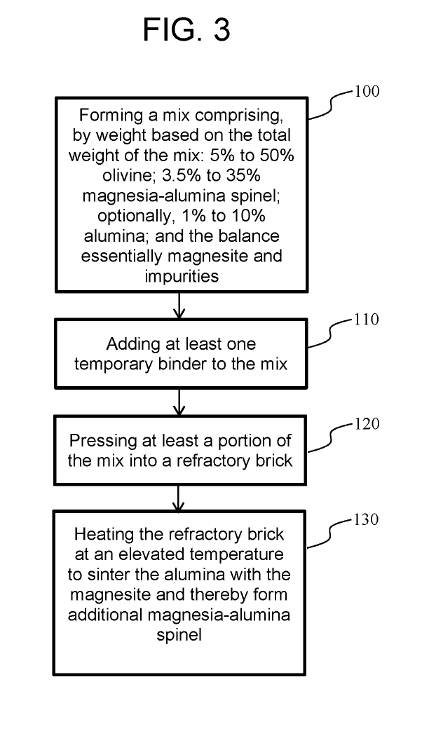

Referring to FIG. 3, the illustrated non-limiting embodiment of a method of forming a refractory brick according to the present disclosure includes forming a mix comprising, by weight based on the total weight of the mix: 5% to 50% olivine; 3.5% to 35% magnesia-alumina spinel; optionally, 1% to 10% alumina; and the balance essentially magnesite and impurities (block 100). At least one temporary binder is added to the mix (block 110), and at least a portion of the mix is pressed to form a refractory brick (block 120). In certain non-limiting embodiments, the temporary binder used is at least one material selected from goulac, silicanit, and dextrin. As known in the art, goulac is a solid calcium lignosulfonate that is a by-product of a sulfite paper process. As also known in the art, silicanit is a solution including, by weight, 50% of goulac, and 50% of water. As further known in the art, dextrin consists of chains of simple sugars, and it can also be used in ultra high alumina brick as an organic temporary binder. The addition of at least one temporary binder can impart a stickiness and cohesion to the mix. The pressed refractory brick is referred to as a “green” brick. The addition of at least one temporary binder can impart a high strength to the green brick, and an even higher strength after the bricks are dried and/or fired, as further explained below. In certain non-limiting embodiments, oil may be added to the mix as a pressing aid. In this regard, oil can serve as a lubricant to improve flow of the mix into press cavities.

In certain non-limiting embodiments, the pressed (green) brick is dried by heating the brick in a conventional manner readily known to those ordinarily skilled in the art of refractory brick production. Water in the temporary binder is evaporated during drying, to avoid pressure build-up and potential cracking during subsequent firing at a higher temperature. In further non-limiting embodiments, the refractory brick is fired or heated to an elevated temperature, e.g., at 1538° C., during which the organic component of the temporary binder is volatilized. Moreover, firing the refractory brick at the elevated temperature can create a ceramic bond that holds the refractory composition together. In further non-limiting embodiments, the alumina is sintered with the magnesite during firing, thereby forming additional magnesia-alumina spinel (block 130). In other embodiments, however, the mix may not include alumina, and the magnesia-alumina spinel is predominantly pre-formed rather than formed in situ. Those having ordinary skill may readily determine, without undue experimentation, suitable heating and firing temperatures for refractory brick according to the present disclosure based, at least in part, on the specific refractory composition in the refractory brick.

### Examples of Certain Non-Limiting Embodiments

Table 1 provides several non-limiting examples of batches of ingredients from which refractory compositions according to the present disclosure were made, along with batches from which conventional refractory compositions were made. All ingredients listed in Table 1 were weighed out to a precision within 0.1 g, and mixed in a laboratory-sized EIRICH mixer.

“MgO 95” as used herein refers to dead-burned magnesite having an MgO content of 95% by weight. The particular MgO 95 used in the examples included, by weight, 95.2% MgO, 1.6% SiO₂, 1.4% CaO, 0.8% Fe₂O₃, and 0.5% Al₂O₃. “3×10” as used herein refers to a particle size distribution in which at least 90% of the particles pass through a 3-mesh sieve (opening size 6.68 mm) and are retained on a 10-mesh sieve (opening size 1.651 mm). “10×28” as used herein refers to a particle size distribution in which at least 90% of the particles pass through a 10-mesh sieve and are retained on a 28-mesh sieve (opening size 0.589 mm). “−28 Mesh” as used herein refers to a particle size distribution in which at least 90% of the particles pass through a 28-mesh sieve. The particular MgO used in the examples further included ball-milled fine (BMF) material. “BMF65” as used herein refers to a particle size distribution in which 65% passes of the particles pass through 325 mesh screen (opening size 0.044 mm).

Although examples of possible MgO content and particle sizes are given in Table 1, these examples do not encompass all possible options for the MgO content and the particle sizes. Rather, the present inventor determined that the MgO content and particle sizes given in Table 1 represent possible particle sizes that can produce embodiments of the refractory compositions. It is to be understood that the compositions, methods, and articles of the present disclosure may incorporate other suitable MgO contents and particle sizes. Dead-burned magnesites available from naturally occurring ores may have an MgO content of, for example, 95.7%, 97%, or 97.8%, by weight. Dead-burned magnesites obtained by processing magnesium chloride brines, such as, for example, those available from Martin Marietta Magnesia Specialties, LLC in Baltimore, Md., Nedmag Industries Mining & Manufacturing B.V. in the Netherlands, and Petioles Metals & Chemicals in Mexico, may have an MgO content of 98-99% by weight. Depending on the use requirements or preferences for the particular refractory composition, the dead-burned magnesite may have an MgO content less than 95%, e.g., 88-95%, by weight. In certain non-limiting embodiments, the dead-burned magnesite as used herein can include at least one of (1) a virgin or unused raw material, and (2) a recycled raw material that is either self-generated during brick production or obtained by processing unused or spent bricks from other kilns.

The particular synthesized olivine used in the examples included, by weight, 38-45% MgO, 39-47% SiO₂, 7-10% Fe₂O₃, 0.3-1.3% Al₂O₃, 0.8-1% CaO, and 1.0-2.0% other oxides. It is to be understood that the compositions, methods, and articles of the present disclosure may incorporate an olivine having other compositions. “4×10” as used herein refers to a particle size distribution in which at least 90% of the particles pass through a 4-mesh sieve (opening size 4.76 mm) and are retained on a 10-mesh sieve. Although certain examples of particle size for olivine are given in Table 1, these examples do not encompass all possible options for the olivine particle sizes. Rather, the present inventor determined that the olivine particle sizes given in Table 1 represent possible particle sizes that can produce certain embodiments of the refractory composition. It is to be understood that the compositions, methods, and articles of the present disclosure may incorporate other suitable olivine particle sizes.

The particular spinel used in the examples was Bauxite Spinel (BXS-65) available from Washington Mills, Niagara Falls, N.Y., which included, by weight, 65.8% Al₂O₃, 29.6% MgO, 2.5% TiO₂, 1.21% SiO₂, 0.58% Fe₂O₃, 0.35% CaO, and 0.09% Cr₂O₃. It is to be understood that the compositions, methods, and articles of the present disclosure may incorporate a spinel having other compositions. For example, the spinel can include, by weight, at least 63.0% Al₂O₃ and 31.0-35.0% MgO. “−6 Mesh” as used herein refers to a particle size distribution in which at least 90% of the particles pass through a 6-mesh sieve (opening size 3.36 mm). Although one example of particle size for the spinel is given in Table 1, this example does not encompass all possible options for the spinel particle size. Rather, the present inventor determined that the spinel particle size given in Table 1 represents a possible particle size that can produce one embodiment of the refractory composition. It is to be understood that the compositions, methods, and articles of the present disclosure may incorporate other suitable spinel particle sizes.

Each batch of ingredients listed in Table 1 was dry-mixed for 30 seconds, and subsequently oil was added to certain embodiments (the first, second, and third embodiments) and mixed together with the batch for another 45 seconds. In the conventional composition and all embodiments, silicanit was added and mixed together with the batch for 90 seconds, after which the mix was manually tested for pressibility. In the conventional refractory composition and the first and third embodiments of the present refractory composition listed in Table 1, water was added to optimize the pressibility of the mix. Sample bars were pressed with a 70-ton load, corresponding to approximately 99 MPa.

The green pressed bars were dried, and the dried bars were fired at 1538° C. for 5 hours. Table 2 provides certain measured properties of the green and dried bars made from the experimental and conventional refractory compositions listed in Table 1. The density of the green and dried bars is provided, along with the change in length of green bars on firing. The reduction in linear change (%) after firing dried bars at 1538° C. (also referred to as the burning expansion) of the fourth embodiment was unexpected and surprising. The reduced burning expansion can be desirable for control of fired brick sizing. Modulus of rupture and apparent porosity of the fired bars also are reported.

TABLE 1

| | | First | Second | Third | Fourth | Fifth |
|---|---|---|---|---|---|---|
| | | Embodiment | Embodiment | Embodiment | Embodiment | Embodiment |
| | Conventional | of Present | of Present | of Present | of Present | of Present |
| | Refractory | Refractory | Refractory | Refractory | Refractory | Refractory |
| | Composition | Composition | Composition | Composition | Composition | Composition |
| Materials | (wt %) | (wt %) | (wt %) | (wt %) | (wt %) | (wt %) |
| 3 × 10 | 29.7 | 9.1 | 9.0 | — | — | — |
| MgO 95 | | | | | | |
| 4 × 10 | — | — | — | 15.0 | 28.2 | 32.1 |
| MgO 95 | | | | | | |
| 10 × 28 | 17.5 | 18.2 | 18.0 | 15.0 | — | — |
| MgO 95 | | | | | | |
| −28 Mesh | 17.5 | 22.7 | 23.0 | 20.0 | 19.1 | 14.5 |
| MgO 95 | | | | | | |
| 95% MgO | 19.7 | 20.0 | 15.0 | 15.0 | 19.1 | 14.5 |
| BMF65 | | | | | | |
| 4 × 10 | — | 20.0 | 20.0 | 13.5 | — | — |
| Olivine | | | | | | |
| 10 × 20 | — | — | — | 6.5 | 9.6 | — |
| Olivine | | | | | | |
| 12 × 40 | — | — | — | — | — | 18.7 |
| Olivine | | | | | | |
| 30 × 60 | — | — | — | — | 9.6 | — |
| Olivine | | | | | | |
| 120 × 150 | — | — | — | — | 4.8 | 5.2 |
| Olivine | | | | | | |
| −6 Mesh | 11.2 | 10.0 | 10.0 | 10.0 | 9.6 | 9.8 |
| Spinel | | | | | | |
| Calcined | 4.4 | 0.0 | 5.0 | 5.0 | — | 5.2 |
| Alumina | | | | | | |
| Total | 100.0 | 100.0 | 100.0 | 100.0 | 100.0 | 100.0 |
| Plus | | | | | | |
| additions | | | | | | |
| Oil | 0.18 | 0.21 | 0.19 | 0.19 | — | — |
| Silicanit | 3.36 | 3.42 | 3.62 | 3.37 | 3.38 | 3.50 |
| Water | 0.08 | 0.09 | 0.00 | 0.10 | 0.00 | 0.00 |

TABLE 2

| | | First | Second | Third | Fourth | Fifth |
|---|---|---|---|---|---|---|
| | | Embodiment | Embodiment | Embodiment | Embodiment | Embodiment |
| | Conventional | of Present | of Present | of Present | of Present | of Present |
| | Refractory | Refractory | Refractory | Refractory | Refractory | Refractory |
| Property | Composition | Composition | Composition | Composition | Composition | Composition |
| Green | 2.891 | 2.821 | 2.818 | 2.803 | 2.722 | 2.835 |
| Density | | | | | | |
| (g/cm³) | | | | | | |
| Dried Density | 2.864 | 2.790 | 2.782 | 2.611 | 2.659 | 2.643 |
| (g/cm³) | | | | | | |
| Linear | −0.14 | +0.96 | +1.42 | +1.06 | +0.12 | +1.13 |
| Change (%) | | | | | | |
| After Firing | | | | | | |
| Dried Bars at | | | | | | |
| 1538° C. | | | | | | |
| Modulus of | 4.7 | 4.2 | 4.8 | 4.9 | 5.0 | 4.4 |
| Rupture | | | | | | |
| (MPa) at | | | | | | |
| Room | | | | | | |
| Temperature | | | | | | |
| Apparent | 16.22 | 18.06 | 19.12 | 22.1 | 20.4 | 21.8 |
| Porosity (%) | | | | | | |
| for Fired Bars | | | | | | |

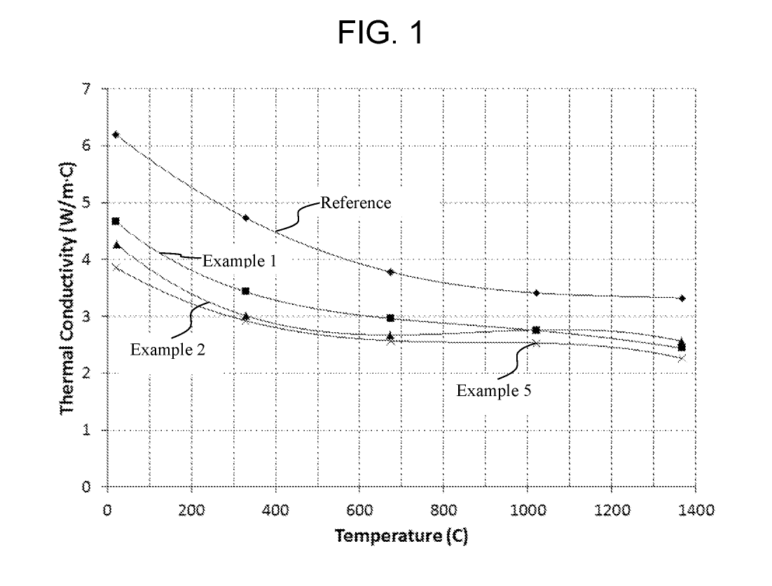

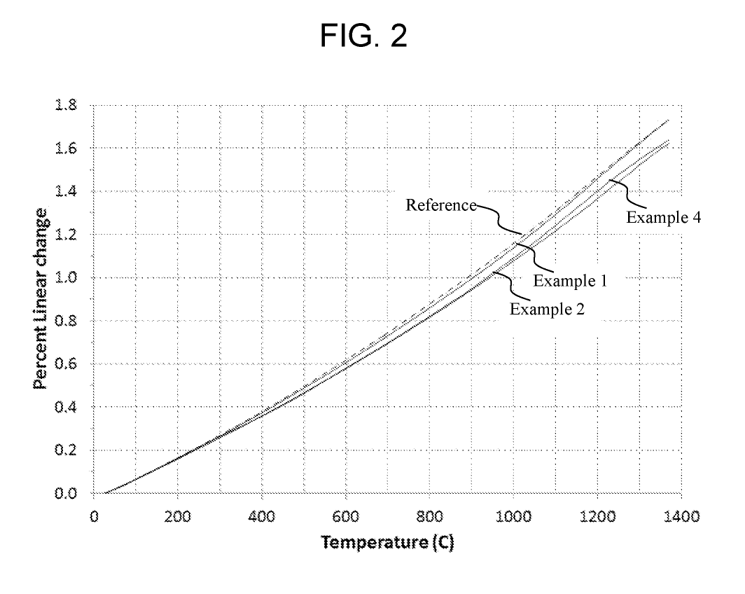

The thermal properties of bars made from certain embodiments of refractory compositions listed in Table 1 were measured and compared to those of bars made from the listed conventional refractory composition. The thermal conductivities are shown in FIG. 1. The thermal conductivity tests were conducted according to the American Society for Testing and Materials (ASTM) standard C-1113 hot wire method. The linear thermal expansion for the conventional refractory composition and the embodiments of the refractory composition were determined using an Orton Dilatometer Model 1600D, and they are shown in FIG. 2.

As shown by the experimental results in FIG. 1, the tested experimental refractory composition exhibited a thermal conductivity that is 22-38% less than that of the conventional refractory composition, depending on the temperature. As discussed above, the reduced thermal conductivity is advantageous for insulating the burning zone and thereby protecting a kiln shell. In addition, the reduced thermal conductivity is advantageous for maintaining the efficiency of the kiln, because a high kiln shell temperature can increase heat loss, which can reduce the operating temperature in the burning zone of the kiln and/or reduce process efficiency.

As shown by the experimental results in FIG. 2, the bars made from the tested experimental refractory compositions exhibited a linear thermal expansion less than that of bars of the conventional refractory composition, in a temperature range up to approximately 1371° C. The reduction in linear thermal expansion of the embodiments of the refractory composition was unexpected and surprising. In particular, the significant magnitude of reductions in linear thermal expansion of the second and fourth embodiment experimental refractory compositions were unexpected and surprising. The reduced thermal expansion indicates that the experimental refractory compositions of the present disclosure should survive service conditions in a rotary kiln burning zone.

Although the foregoing description has necessarily presented only a limited number of embodiments, those of ordinary skill in the relevant art will appreciate that various changes in the compositions, methods, articles, and other details of the examples that have been described and illustrated herein may be made by those skilled in the art, and all such modifications will remain within the principle and scope of the present disclosure as expressed herein and in the appended claims. It is understood, therefore, that the present invention is not limited to the particular embodiments disclosed or incorporated herein, but is intended to cover modifications that are within the principle and scope of the invention, as defined by the claims. It will also be appreciated by those skilled in the art that changes could be made to the embodiments above without departing from the broad inventive concept thereof.

We claim:

1. A refractory brick including a refractory composition comprising, by weight based on total weight of the composition:
5% to 50% olivine;
3.5% to 35% magnesia-alumina spinel;
optionally, 1% to 10% alumina; and
the balance essentially magnesite and impurities.

2. The refractory brick of claim 1, wherein the olivine includes one selected from naturally occurring olivine and synthesized olivine.

3. The refractory brick of claim 1, wherein olivine content of the refractory composition is 20% to 24%, by weight.

4. The refractory brick of claim 1, wherein magnesia-alumina spinel content of the refractory composition is 9.6% to 10%, by weight.

5. The refractory brick of claim 1, wherein the magnesite of the refractory composition has an MgO content of 88% to 99%, by weight.

6. The refractory brick of claim 1, wherein the magnesite of the refractory composition has a total lime and silica content of 0.7% to 10%, by weight.

7. The refractory brick of claim 1, wherein the magnesite of the refractory composition comprises at least one material selected from dead-burned magnesite and fused magnesite.

8. The refractory brick of claim 1, wherein the refractory composition comprises, by weight, 5% to 5.2% alumina.

9. The refractory brick of claim 8, wherein the alumina of the refractory composition is sintered with the magnesite, thereby forming additional magnesia-alumina spinel.

10. The refractory brick of claim 1, wherein the refractory composition has a thermal conductivity of 2.6 W/(m·K) or less at 1400° C.

11. The refractory brick of claim 1, wherein the refractory composition has a thermal conductivity of approximately 2.5 W/(m·K) at 1093° C.

12. The refractory brick of claim 1, wherein the refractory composition has a coefficient of thermal expansion of 12.6×10⁶/° C. or less.

13. A kiln including a plurality of refractory bricks as recited in claim 1.

14. A method of utilizing refractory bricks, the method comprising:
assembling a plurality of refractory bricks as recited in claim 1 around a kiln surface to form an insulating liner.

15. A method of forming a refractory brick comprising:
forming a mix comprising, by weight based on the total weight of the mix, 5% to 50% olivine, 3.5% to 35% magnesia-alumina spinel, optionally, 1% to 10% alumina, and the balance essentially magnesite and impurities;
adding at least one temporary binder to the mix; and
pressing at least a portion of the mix into a refractory brick.

16. The method of claim 15, wherein the olivine includes one selected from naturally occurring olivine and synthesized olivine.

17. The method of claim 15, wherein olivine content of the mix is 20% to 24%, by weight.

18. The method of claim 15, wherein magnesia-alumina spinel content of the mix is 9.6% to 10%, by weight.

19. The method of claim 15, wherein the magnesite of the mix has an MgO content of 88% to 99%, by weight.

20. The method of claim 15, wherein the magnesite of the mix has a total lime and silica content of 0.7% to 10%, by weight.

21. The method of claim 15, wherein the magnesite of the mix comprises at least one material selected from dead-burned magnesite and fused magnesite.

22. The method of claim 15, wherein the mix comprises, by weight, 5% to 5.2% alumina.

23. The method of claim 22, further comprising heating the refractory brick at an elevated temperature to sinter the alumina with the magnesite and thereby form additional magnesia-alumina spinel.
